(19) United States
(12) Patent Application Publication
(10) Pub. No.: US 2024/0403868 A1
(43) Pub. Date: Dec. 5, 2024

(54) SYSTEM AND METHOD FOR MANAGING PRODUCT OWNERSHIP

(71) Applicant: Vera Services Inc., Miami, FL (US)

(72) Inventor: Spencer Stebbins, Miami, FL (US)

(21) Appl. No.: 18/678,490

(22) Filed: May 30, 2024

Related U.S. Application Data
(60) Provisional application No. 63/504,846, filed on May 30, 2023.

(51) Int. Cl. G06Q 20/38

(52) U.S. Cl. CPC G06Q 20/38215; G06Q 20/389

(57) ABSTRACT

A system and method for managing product authenticity, ownership, and traceability are provided. The system may include an electronic tag having a tag ID where electronic tag may be incorporated into a product having a product ID. The system may further include an electronic ledger associating the tag ID, the product ID, and ownership information for the product. The system may further include devices capable of scanning the electronic tags such as through NFC or RFID, where the devices may provide interfaces for transferring ownership of the product, authenticating the product, locating the product, and/or reporting that the product is lost or missing.

### CROSS-REFERENCE TO RELATED APPLICATION

This application claims the benefit of co-pending U.S. Provisional Patent Application No. 63/504,846, filed May 30, 2023 the entire contents of which are incorporated by reference.

### FIELD

This disclosure generally relates to a system for managing an ownership of a product. Specifically, this disclosure relates to using electronic identifications and a database to tracking ownership for goods and merchandises.

### BACKGROUND OF THE INVENTION

Products such as handbags, watches, or jewelries often have high retail prices. Fakes and counterfeits are thus common issues in luxury goods industries.

Traditionally, the best way to guarantee that a product is genuine is to purchase the product directly from the original manufacturer, a retailer, or a trusted resale authority.

Once a product is purchased from a retailer, methods of ensuring authenticity become problematic. Some known methods may include using authenticity cards, stock keeping units (SKU) or serial numbers, receipts or proofs of purchase, or by manually examining a product to look for details that may indicate its authenticity. However, as counterfeiters become more sophisticated, these common authentication methods can often be forged or faked. For example, a counterfeit product may also contain a serial number and/or an authenticity card that is a spoof of a genuine product, making the authenticity of the counterfeit product difficult if not impossible to determine.

Moreover, even if a product is purchased directly from a retailer, it may be difficult for the buyer to subsequently prove the authenticity of the product during a resale transaction as it may be difficult for a secondhand buyer to authenticate the product given that authenticity cards, receipts, or serial numbers may all be forged.

As such, there is a need for a system and method to track ownership for a good or merchandise to more easily ensure the authenticity and genuineness of the good or merchandise.

Further still, a retailer currently lacks means to collect data pertaining to a product after the product is sold. Therefore, there is also a need for a system and method to collect post-sale data of products sold.

### BRIEF SUMMARY OF THE INVENTION

A first aspect of this disclosure pertains to a system for managing product ownership comprising a tag incorporated into a product, the tag having a tag ID; an electronic certificate unique to the product; and a processor configured to associate the electronic certificate with the tag; and record ownership information of the product in the electronic certificate.

A second aspect of this disclosure pertains to the system of the first aspect, wherein the electronic certificate is stored in an electronic ledger.

A third aspect of this disclosure pertains to the system of the second aspect, wherein the electronic ledger is a blockchain.

A fourth aspect of this disclosure pertains to the system of the third aspect, wherein the tag is a near-field communication (NFC) tag.

A fifth aspect of this disclosure pertains to the system of the first aspect, wherein the processor is further configured to update the ownership information in the electronic certificate in response to a change in ownership of the product.

A sixth aspect of this disclosure pertains to the system of the first aspect, wherein the processor is further configured to record a product ID, the tag ID, and a scan history of the tag in the electronic certificate.

A seventh aspect of this disclosure pertains to a method for managing product ownership comprising scanning, by a device, an electronic tag having a tag ID; transmitting, by the device, the tag ID to a server; matching, by the server, the tag ID to a certificate associated with a product; retrieving, by the server, a product information and an ownership information based on the certificate; transmitting, by the server, the product information and the ownership information to the device; and displaying, by the device, the product information and the ownership information on an interface.

An eighth aspect of this disclosure pertains to the method of the seventh aspect further comprising associating the tag ID with the certificate; associating the certificate with a current owner; and registering the certificate in a ledger.

A ninth aspect of this disclosure pertains to the method of the eighth aspect, wherein the ledger includes a blockchain.

A tenth aspect of this disclosure pertains to the method of the eighth aspect further comprising verifying, by the server, a tap token with the tag ID.

An eleventh aspect of this disclosure pertains to a method for managing product ownership comprising scanning a tag associated with a certificate unique to a product, the tag having a tag ID and the product having a product ID; associating an ownership information with the certificate; and in response to a transfer of ownership, updating the ownership information to reflect a new owner of the product.

A twelfth aspect of this disclosure pertains to the method of the eleventh aspect further comprising recording a first entry including the tag ID, the product ID, and the ownership information on a ledger.

A thirteenth aspect of this disclosure pertains to the method of the twelfth aspect, wherein the ledger includes a blockchain.

A fourteenth aspect of this disclosure pertains to the method of the twelfth aspect, wherein updating the ownership information further comprises recording a second entry including the tag ID, the product ID, information pertaining to a new first party in the ledger.

A fifteenth aspect of this disclosure pertains to the method of the eleventh aspect further comprising: selecting, by a first party, a second party of whom to transfer an ownership of the product; receiving, by the second party, a notification indicating that a transfer of ownership of the product is pending; scanning, by the second party, the electronic tag; and accepting, by the second party, the ownership of the product from the first party.

A sixteenth aspect of this disclosure pertains to the method of the fifteenth aspect, wherein selecting the second party further comprises providing a first interface on a first device for the first party to select the second party.

A seventeenth aspect of this disclosure pertains to the method of the fifteenth aspect, wherein receiving a notification further comprises providing a second interface including the notification on a second device to the second party.

An eighteenth aspect of this disclosure pertains to the method of the fifteenth aspect further comprising providing a fourth interface to a first party of the product that the product is lost or missing.

A nineteenth aspect of this disclosure pertains to the method of the eleventh aspect, further comprising providing a fourth interface to a first party of the product that the product is lost or missing.

A twentieth aspect of this disclosure pertains to the method of the nineteenth aspect further comprising in response to the electronic tag being scanned after the product has been reported as lost or missing, notifying the first party of the product.

### BRIEF DESCRIPTION OF THE DRAWINGS

FIG. 1 illustrates a system for tracking ownership according to an embodiment;

FIG. 2 illustrates an electronic tag a system for tracking ownership according to an embodiment;

FIG. 3 illustrates a process for transferring ownership from an organization to a first party according to an embodiment;

FIG. 4 illustrates a process for transferring ownership from a first party to a second party according to an embodiment;

FIG. 5 illustrates a process for handling a missing or loss event according to an embodiment;

FIG. 6 illustrates a process for authentication according to an embodiment;

FIG. 7 illustrates a certificate management interface according to an embodiment;

FIG. 8 illustrates a certificate displayed on an interface according to an embodiment;

FIG. 9 illustrates another certificate management interface according to an embodiment;

FIG. 10 illustrates a dashboard for analyzing certificates according to an embodiment; and

FIG. 11 illustrates a process for authentication according to an embodiment.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While this invention is susceptible of embodiments in many different forms, there are shown in the drawings and will be described in detail herein specific embodiments with the understanding that the present disclosure is an exemplification of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention.

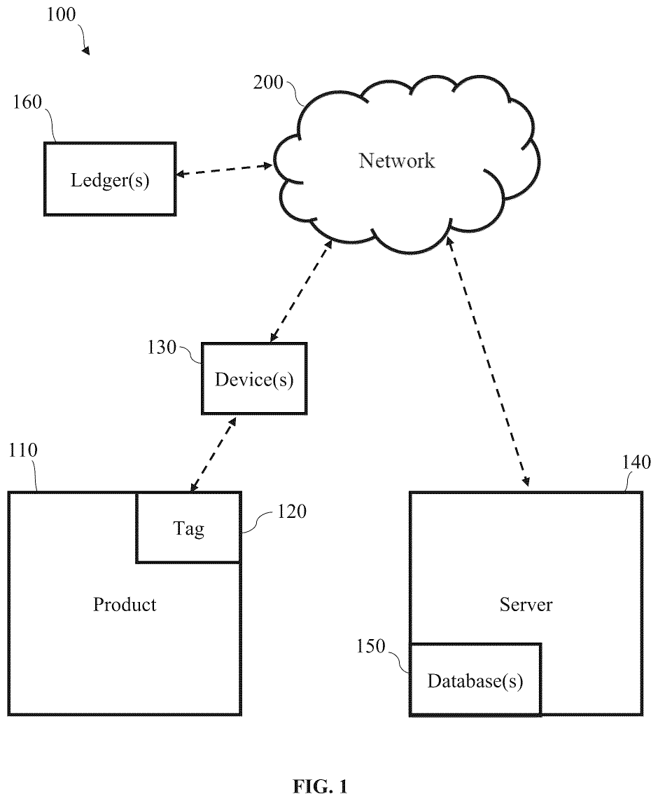

FIGS. 1-10 illustrate systems and methods for tracking ownership according to various embodiments. Referring to FIG. 1, a system 100 for tracking ownership may include a product 110. The product 110 may be high value goods such as a handbag, a watch, or a piece of jewelry. In other embodiments, the product 110 may be a car, a pallet, a piece of machinery. In further embodiments, the product 110 may be a parcel of real property. It is to be appreciated that the product 110 may be any object such that tracking its chain of title or ownership may be desired for any reasons.

The system 100 may include a tag 120. The tag 120 may be an electronic tag in the form of a radio-frequency identification (RFID) tag, a near field communication (NFC) tag, a Bluetooth beacon, or other suitable tags. The tag 120 may be read wirelessly to convey certain information. For example, the tag 120 may be configured to transmit a tag identification (ID) when read by a device 130. In additional embodiments, the tag 120 may be read through physical contact, such as by inserting the tag 120 into the device 130 or scanning the tag 120 by the device 130, or through a hardware tag-reading device connected with a hardwired connection such as through Universal Serial Bus (USB).

The tag 120 may be a part of, embedded, or otherwise included in or on the product 110. For example, the tag 120 may be provided behind a handbag label, on a watch case, inside a jewelry box, and the like. Alternatively or additionally, the tag 120 may be a part of, embedded, or otherwise included in or on an authenticity card that may be provided together with the product 110. In some embodiments, the tag 120 may be provided with a crate or a parcel. In further embodiments, the tag 120 may be affixed to documents or other articles.

The tag 120 may be configured to transmit an array of information when read by the device 130. Some of the information may include the tag ID, one or more Uniform Resource Locators (URL) (such as an URL for a service provider, a manufacturer, a retailer, or the like), a tap token, and/or other information or data. In some embodiments, the URL provided by the tag 120 may direct the device 130 to a third-party provider (e.g., the Vera platform), where the tag ID may be cryptographically checked, before redirecting the device 130 to website for the manufacturer or a company.

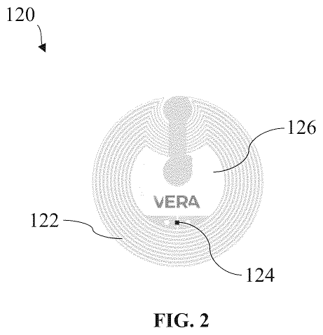

Referring briefly to FIG. 2, and example of the tag 120 is illustrated. In this example, the tag 120 may be in the form of an NFC tag, such as but not limited to, an RFID tag. The tag 120 may include an antenna 122 coupled to a chip 124. The antenna 122 and the chip 124 may be provided on a substrate 126.

Returning to FIG. 1, the system 100 may also include one or more devices 130. The device 130 may be a mobile phone, a tablet, a personal computer, a laptop computer, a point-of-sale (POS) system, or other suitable devices. The device 130 may be configured such that the device 130 is capable of reading the tag 120. For example, if the tag 120 is an NFC tag, the device 130 may include components such as an NFC reader to enable the device 130 to read an NFC tag. Likewise, if the tag 120 is a near field communication (NFC tag, the device 130 may include components such as a NFC reader to enable the device 130 to read a NFC tag.

The device 130 may include a memory with one or more applications (apps) or programs stored thereon. The apps (such as a browser or a standalone app) may access one or more interfaces such a customer-facing interface that may be embedded at an organization's website and/or a organization-facing interface such as a portal for managing various systems. The device 130 may also include a processor coupled to the memory such that the processor may be configured to execute the application. Moreover, the device 130 may include one or more communicators, receivers, and/or transceivers such that the device 130 may further be connected to a network 200.

The network 200 may be in the form of a cellular network, satellite, internet, intranet, or other suitable networks. In addition, the network 200 may be a combination of wired and/or wireless networks. For example, the network 200 may be in the form of a cellular network and the internet. In another example, the network 200 may be in the form of Wi-Fi and the internet. Certainly, other variations are the network 200 are also possible and are contemplated herein.

The network 200 may further be connected to one or more servers 140 which may house one or more databases 150 in a localized and/or a distributed fashion. Moreover, the network 200 may further be connected to one or more ledgers 160, which may be provided as electronic ledgers on one or more blockchains to ensure the data on the ledger cannot be manipulated or falsified and/or on one or more databases.

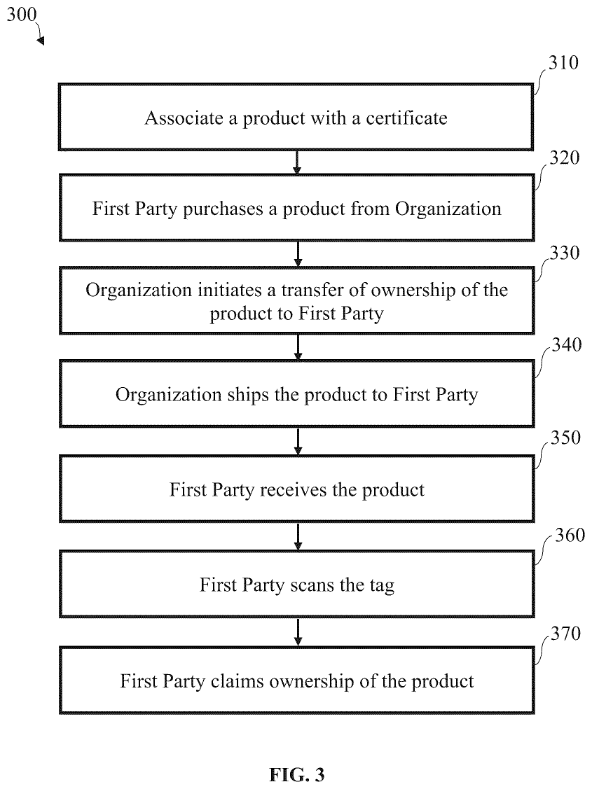

FIG. 3 illustrates a process 300 for transferring ownership of a product from an organization to a first party. Here, the product may refer to the product 110 of FIG. 1, which may have the tag 120 embedded thereon. Alternatively or additionally, the tag 120 may otherwise be associated with the product 110 such as through an authenticity card that may be provided to the first party. Moreover, the organization may refer to a store operated by a designer (such as a flagship store), a store operated by a related third-party (such as an authorized dealer), a store operated by an unrelated third-party (such as a department store, marketplaces, auction houses, The Real Real, Sothebys, ebay, or the like), or any other stores that carry the product. The store may be a brick-and-mortar store and/or an ecommerce store.

At step 310, the organization and/or another party (such as a manufacture, a brand, a designer, and the like) (collectively, an “assigning party”) may associate the product with a certificate. The certificate may be unique to each individual item. For example, if the organization produces ten purses, each purse may have a unique certificate.

In some embodiments, one or more certificates may be pre-generated prior to the production of the product, where a certificate may be assigned to a product once the product is produced. In other embodiments, a certificate may be generated on-demand to be associated with a product.

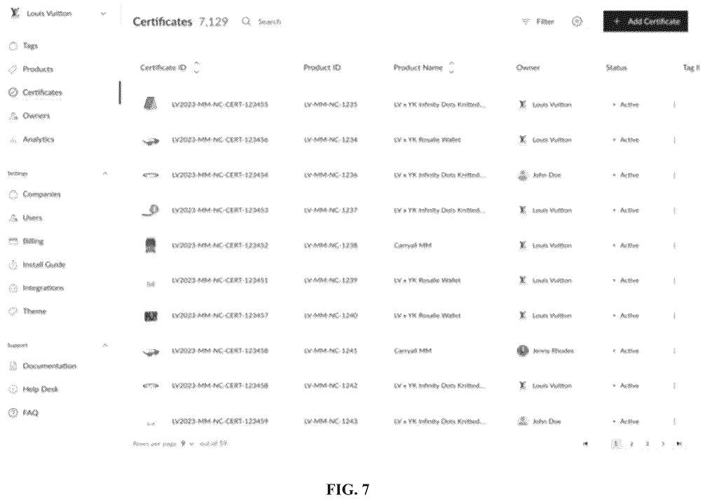

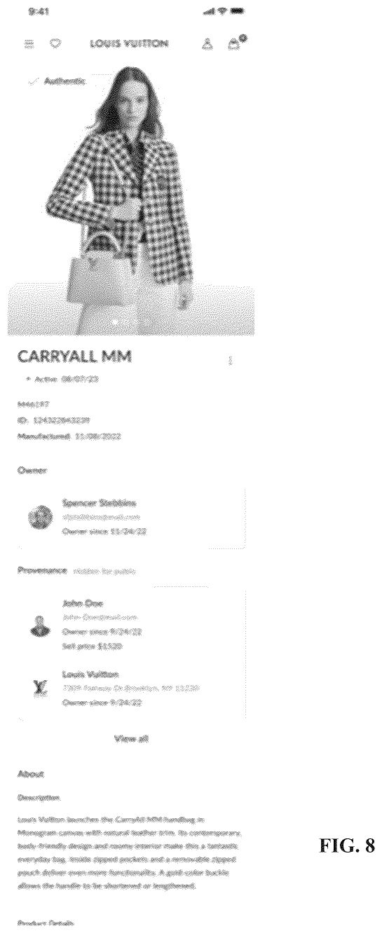

At step 310, to assign a certificate to a product, the assigning party may select an unused certificate (such as selecting from a list of certificates on a website) and encode the tag 120 of the product 110 to be associated with the certificate. In some embodiments, the assigning party may further input additional fields pertaining to the product 110 into the certificate. Alternatively or additionally, the additional fields may be generated by a third-party provider. For example, referring to FIG. 7, a certificate may include a product ID of the product 110 that the certificate is associated with, a product name, a tag ID of the tag 120, a status indicator (such as active, inactive, transfer, lost, or the likes), a current owner, a last scanned location indicating a geographic location where the tag 120 was last scanned, and a number of scans (counting an amount of times that the tag 120 has been scanned). Referring to FIG. 8, other fields of the certificate may include a manufacture date, a brief description of the product, and a detail description of the product, some or all of which may be retrieved from an inventory management system (such as Shopify or the likes). The certificate may also include additional fields such as a provenance (such prior and/or current owner(s) and ownership date) as well as a scan history.

At step 320, the first party may purchase the product from the organization, which may take place in person at a brick-and-mortar store and/or virtually over the internet or over the phone.

At step 330, once the first party has purchased the product, the organization may initiate a transfer of ownership of the product to the first party. This step may be performed by the store at a point-of-sale (POS) system, though an app, a program on a computer, and/or on a website.

In some embodiments, the step 330 may include the first party registering with the brand's website (which may be maintained by the organization and/or by a third-party provider). The registration may include providing certain first party information such as name, address, email address, phone number, birthday, gender, and/or other information related to the first party. Therefrom, the organization may be able to search for the first party on the brand's website and/or on the third-party provider (e.g., Vera platform) to initiate the transfer. In some embodiments, the organization may be able to select the first party from a database containing a list of all individuals that have registered with the brand.

Once the specific first party is selected, the organization may be presented with an option to transfer ownership of a product. This option may be in the form of an icon, a drop-down option, or the like.

Once the organization selects the option to transfer ownership of a product, the organization may scan the tag 120 to retrieve information of the specific product to be transferred to the first party. Alternatively or additionally, the organization may scan a barcode or through other suitable methods to identify the specific product that was sold.

The organization may then be presented with a confirmation screen and/or a popup, confirming that the selected product and the selected first party are correct. Thereafter, the organization may press a button or icon to initiate the ownership transfer. In further embodiments, the confirmation may be performed automatically by the inventory management system, such that the confirmation may automatically be triggered when the first party purchases the product directly from the organization (such as through the organization's website or app).

At step 340, the organization may ship the product to the first party, and at step 350, the first party may receive the shipped product. As can be appreciated, if the first party is shopping at a brick-and-mortar store, step 340 and step 350 may be omitted. Instead, the first party may take physical possession of the product.

Once the organization initiates a transfer of ownership at step 330, the first party's mobile phone (or other devices) may receive a notification indicating the organization is attempting to transfer ownership of the product to the first party. However, the first party may not be able to claim ownership until the first party is able to scan the tag 120, indicating that the first party has physical possession of the product.

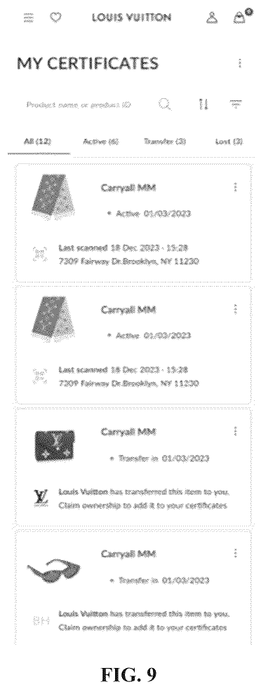

Upon receiving the notification, the first party's device 130 may be directed to an interface such as a website or an app maintained by the organization or a third-party service provider. The first party may then create or log into their user account on the website or app. FIG. 9 illustrates an example interface for the first party to manage one or more certificate(s).

At step 360, the first party may scan the tag 120 through a device 130, confirming that the first party has physical possession of the product. Here, the device 130 may be the first party's mobile phone, tablet, or the like.

At step 370, once the first party scans the tag 120 at step 360 and confirm claims ownership of the product, the certificate may be updated to reflect the new ownership by the first party being the party that is currently logged in to the interface. In some embodiments, the first party scanning the tag 120 may trigger claiming ownership without further steps.

A current owner of the product may be tracked in the certificate through the ledger 160. In an example, when the tag 120 is first associated to the product 110, a transaction or an entry may be made at the ledger 160 that indicates the organization is the current owner of the product 110 and is thus the product 110's rightful owner. The ledger 160 may record information included in the certificate, such as the tag ID of the tag 120, the product ID (such as a unique serial number or a SKU) of the product 110 associated with the tag 120, the current owner, or the like. Additional information may also be recorded at the ledger 160 as well, such as a product title, description, provenance, purchase price, a purchase date, or other desired information. Additionally or alternatively, additional information may be retrieved from the inventory management system without having to be recorded at the ledger 160.

Once the first party successfully claims ownership of the product at step 370, another transaction or entry may be made on the ledger that indicates a transfer of certificate owner from the organization to the first party. For example, another entry may be made to reflect that the certificate owner of the product 110 is now the first party, and thus the first party is now associated with the certificate unique to the product.

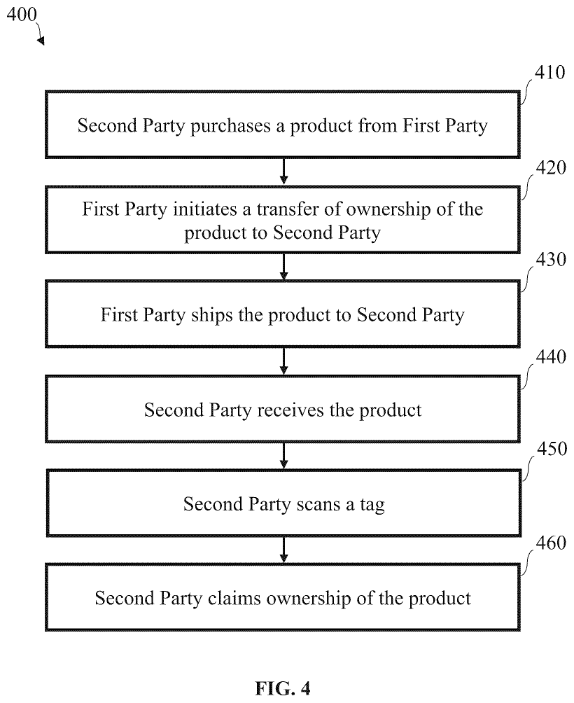

FIG. 4 illustrates a process 400 for transferring ownership of a product from a first party to a second party, such as for a second-hand resale. The process 400 is substantially similar to the process 300 previously described, with the difference being the parties involved an organization and a first party in the process 300, and a first party and a second party in the process 400.

At step 410, a second party may purchase a product from the first party. Here, the second party may refer to an individual or entity that is purchasing a product used or second-hand. The first party may refer to an individual or entity that originally purchased the product from the organization (i.e., purchased the product “new”). However, it is to be appreciated that the process 400 can also apply to any further second party.

At step 420, once the second party purchased the product, the first party may initiate a transfer of ownership of the product to the second party. This step may be performed through an app, a program on a computer, and/or on a website.

In some embodiments, the step 420 may include the second party also registering with the brand's website. The registration may include providing certain first party information such as name, address, email address, phone number, birthday, gender, and/or other information related to the second party. Therefrom, the first party may be able to search for the second party on the brand's website to initiate the transfer. In some embodiments, the database containing a list of all individuals that have registered with the organization may be available to the first party such that the second party may be selected from the list.

Once the specific second party is selected, the first party may be presented with an option to transfer ownership of the product. This option may be in the form of an icon, a drop-down option, or the like.

Once the first party selects the option to transfer ownership of the product, the first party may scan the tag 120 confirm that the product is in possession of the first party and to confirm transfer. In some embodiments, the first party may be presented with one or more input fields to input information pertaining to the transfer, such as a transaction value, a transaction date, or other information.

The first party may then be presented with a confirmation screen and/or a popup, confirming that the selected product and the selected second party are correct. The first party may be provided with an option to show their ownership as a part of the provenance after the transfer. For example, on the provenance on the certificate, the first party may be identified as a historical owner by name, or may be identified as an anonymous owner if the first party does not wish to show their ownership. Thereafter, the first party may press a button or icon to initiate the ownership transfer.

At step 430, the first party may ship the product to the second party, and at step 440, the second party may receive the shipped product. As can be appreciated, the first party may also transfer the product to the second party in-person and the step 430 and the step 440 may be omitted.

Once the first party initiates a transfer of ownership at step 420, the second party's mobile phone (or other devices) may receive a notification indicating the first party is attempting to transfer ownership of the product to the second party. However, the second party may not be able to claim ownership until the second party is able to scan the tag 120, indicating that the second party has physical possession of the product.

Upon receiving the notification, the second party's device 130 may be directed to an interface such as a website or an app maintained by the organization or a third-party service provider. The second party may then create or log into their user account on the website or app.

At step 450, the second party may scan the tag 120 through a device 130, confirming that the second party has physical possession of the product. Here, the device 130 may be the second party's mobile phone, tablet, or the like.

At step 460, once the second party scans the tag 120 at step 450 and confirm claims ownership of the product, the certificate may be updated to reflect the new ownership by the second party being the party that is currently logged in to the interface. In some embodiments, the second party scanning the tag 120 may trigger claiming ownership without further steps. Moreover, until the second party successful claims ownership of the product, the first party may cancel the initiated transfer. Should the second party later decide to resell the product, the process 400 may be repeated with a third party.

In some embodiments, the ability to keep track of ownership of the certificate and/or the authenticity of the product may be a premium function. As such, the organization or the third-party provider for the ledger 160 may require one or more payments from a first party and/or a second party in order to maintain the product on the ledger 160.

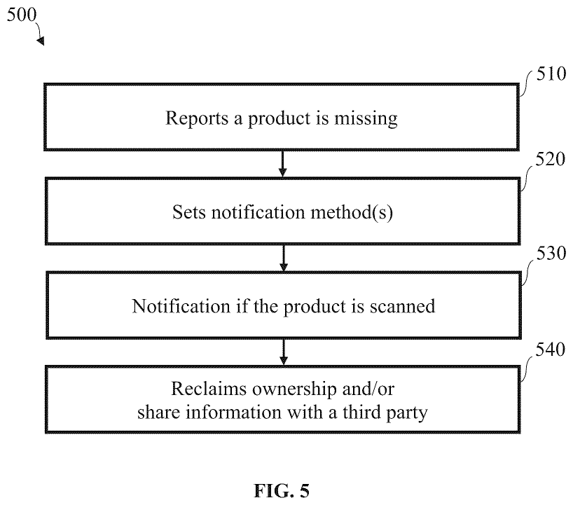

FIG. 5 illustrates a process 500 for handling a missing or loss event. At step 510, the current owner of the certificate (and/or the organization or another party such of law enforcement) may report that a product is missing, lost, or otherwise misplaced. The step 510 may include the current owner logging into an app or a website, where a list of certificates associated with the current owner may be presented in said app or the website (see FIG. 9). Therefrom, the current owner may select the specific product that is missing from the list. In some embodiments, additional parties (such as the organization that originally sold the product) may also report that a product is missing.

At step 520, the current owner may select one or more notification methods to be notified. For example, if the process 500 is implemented in an app, the first party or second party may select one or more of a push notification, a text message, a phone call, or other methods of notification. Similarly, if the process 500 is implemented in a website, the first party or second party may select one or more of an email, a text message, a phone call, or other methods of notification.

At step 530, if the product is scanned by any compatible device, a notification may be received by the current owner who reported that the product is missing. In some embodiments, the organization and/or a third party (such as the law enforcement) may also receive the notification if set or allowed by the first party. The notification at step 530 may include information about the product, such as a description of the product, the product ID, and other relevant information. The notification may also include a geographical information such as a location of where the product was scanned.

In some embodiments, the current owner can create shareable dynamic links to the certificate that hide or show certain elements of the certificate. For example, the current owner may wish to create a shareable dynamic link to share with the police when the product is lost or stolen. In some examples, the current owner may wish to only share ownership information with select individuals. For example, if the product is very expensive and/or for sale (e.g., via a silent auction), the current owner may wish to limit the number of people that can view the ownership information.

At step 540, the current owner may reclaim ownership of the product in the app and/or the website. Additionally or alternatively, the current owner may share the information with a third party such as the law enforcement. For example, the app may include a function that export or share the current location and/or a location history of the product, where the location history may correspond to a scan history for each time the product has been scanned. In some embodiments, it may not be possible to transfer ownership to another party while a product is reported as lost.

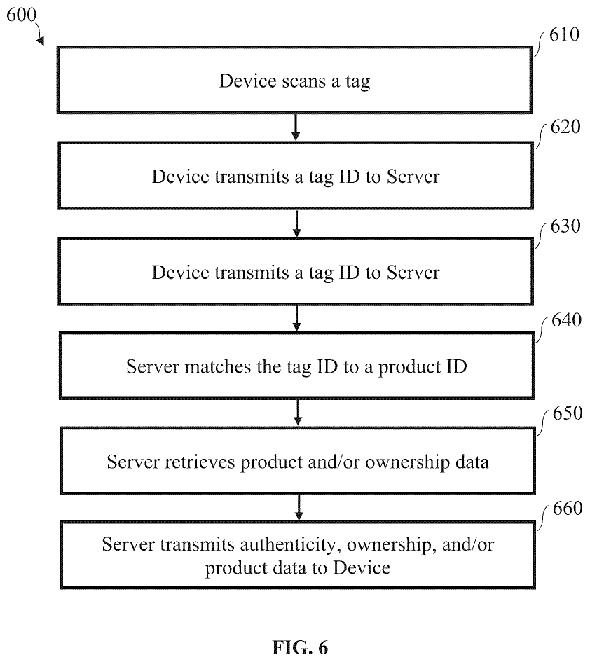

FIG. 6 illustrates a process 600 for authenticating a product. A step 610, the device 130 may scan the tag 120. As discussed previously, the tag 120 may be embedded or otherwise included on a product.

At step 620, the device 130 may transmit one or more messages that may include the tag ID of the tag 120 to a server. The server may be operated by the organization and/or by a third-party provider. Alternatively or additionally, the one or more messages transmitted by the device 130 may also include the tap token of the tag 120. The one or more messages may be transmitted in a secured fashion, such as through an encryption.

At step 630, the server may authenticate and/or confirm that the tap token and the tag ID are authentic.

At step 640, the server may match the tag ID to a product ID stored in the database 150. Moreover, the sever may also verify the tap token received. In some embodiment, if the server is unable to verify the tap token, the process 600 may be terminated, and/or an error message may be received by the device.

At step 650, the server may retrieve product and/or ownership information from the ledger 160. The ownership information may include the current owner, as well as additional information such as a purchase date and/or other relevant information.

At step 660, the server may transmit authenticity information, ownership information, and/or product information, as well as any additional information to the device 130. This information may be displayed on one or more interfaces on the device 130.

A current owner of the certificate may have additional options to manage the one or more certificates that they are the owner of. For example, the current owner may be able to configure what certificate details to share with the public in the form of a public certificate. The current owner may decide to include (or not) the identity of the current owner, the provenance, the scan history (such as geographical history, when it was scanned, by whom was it scanned, or the like), or other information in the public certificate.

Moreover, the current owner may share the public certificate such as by sending a link to the certificate or via email, instant message, social media, or the like. In some embodiments, the current owner may export the public certificate in suitable formats such as a PDF file.

Each time the tag 120 is scanned, either by the current owner or by any third party, the device 130 scanning the tag 120 may be caused to transmit information to the server 140. The information transmitted may include a date and/or time of the scan, the identity of the scanning party (such as the organization, the current owner, an unknown or anonymous party), a geographical location where the scan took place, and the type of device used in the scan. The information may be compiled into a scan history.

An electronic certificate may also include associations with other independent or dependent components each consisting of their own electronic tags. A certificate with dependent components may require the scanning of both tags on transfer. For example, a certificate for a pair of shoes may have each shoe act as a dependent component. In this case, each shoe may include an electronic tag that on sale or transfer of the certificate for the pair, the first party may be required to scan both electronic tags for each shoe to initiate transfer. Independent components are certificates themselves that have product and tag data but maintain the same ownership as the certificate they are associated with until the independent components are sold or transferred independently. Independent components are often used for “bundled” products, which can usually be identified if the organization already sells those products independently or together on their ecommerce or other channel. For example, a watch could be a bundle product consisting of the case and the band that can sold together or separately. If the case and band both are embedded with an electronic tag and sold together, then the case and the band may operate like dependent components. However, if the case and the band are sold separately, that component becomes its own certificate with different ownership and the association that existed is broken.

A service provider maintaining the certificates may generate and/or export a report on one or more certificates via one or more interfaces such as a website. The report may include details of the product associated with the specific certificate (such as product name, product ID, tag ID, current owner, manufactured date, last scan location/place, and/or initial sale date). The report may also include provenance associated with the certificate, which may include historical owner(s), transfer date(s), and contact information of the historical owners, and any other data via a system integration the organization provides to the system. Likewise, the report may also include the scan history.

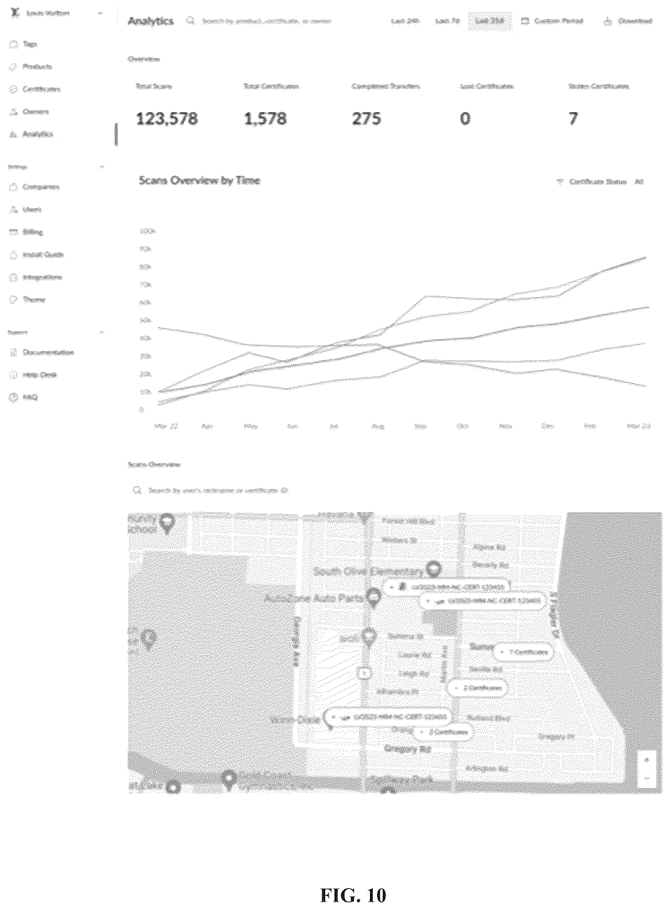

By using the certificates described herein, advance analytics may be generated in one or more dashboards. Referring to FIG. 10, an example dashboard may include an overview of how many scans took place over a period of time, how many certificates were issued, how many transfers took place, how many certificates were reported as lost and/or stolen. One or more plots may be included to analyze the data collected. Moreover, the dashboard may include a compilation of geographical locations where the tags were scanned, which may be represented in the form of a heat map. An organization or a service provider may be able to utilize these information to better service clients or to, and not limited to, create targeted advertisements, marketing, sustainability, reduce return fraud, and other initiatives.

The data generated by the system via certificates scans, ownership transfer, and any interaction may also be utilized to generate specific insights for the organization through the use of a machine learning model or otherwise. An organization or a service provider may be able to utilize this information to better service clients or to, and not limited to, create targeted advertisements, marketing, sustainability, reduce return fraud, and other initiatives.

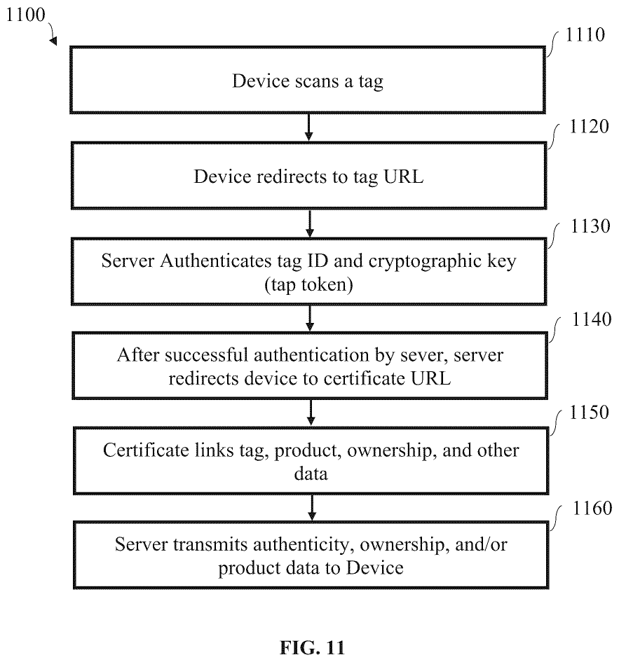

FIG. 11 illustrates a process 1100 for authenticating a product. A step 1110, the device 130 may scan the tag 120. As discussed previously, the tag 120 may be embedded or otherwise included on a product.

At step 1120, the device 130 may be redirected to the URL of the tag 120.

At step 1130, a server authenticates the tag ID and the cryptographic key (e.g., the tap token).

At step 1140, after successful authentication of the tag ID and the cryptographic key by the server, the server redirects the device to the certificate URL.

At step 1150, the certificate links the tag, the product, ownership, and other data.

At step 1160, the server may transmit authenticity information, ownership information, and/or product information, as well as any additional information to the device 130. This information may be displayed on one or more interfaces on the device 130.

Specific embodiments of a system and method for managing product ownership according to the present invention have been described for the purpose of illustrating the manner in which the subject matter of the present disclosure can be made and used. It should be understood that the implementation of other variations and modifications of this disclosure and its different aspects will be apparent to one skilled in the art, and that this disclosure is not limited by the specific embodiments described. Features described in one embodiment can be implemented in other embodiments. The subject disclosure is understood to encompass the present invention and any and all modifications, variations, or equivalents that fall within the spirit and scope of the basic underlying principles disclosed and claimed herein.

What is claimed is:

1. A system for managing product ownership comprising:
a tag incorporated into a product, the tag having a tag ID;
an electronic certificate unique to the product; and
a processor configured to:
associate the electronic certificate with the tag; and
record ownership information of the product in the electronic certificate.

2. The system of claim 1, wherein the electronic certificate is stored in an electronic ledger.

3. The system of claim 2, wherein the electronic ledger is a blockchain.

4. The system of claim 1, wherein the tag is a near-field communication (NFC) tag.

5. The system of claim 1, wherein the processor is further configured to update the ownership information in the electronic certificate in response to a change in ownership of the product.

6. The system of claim 1, wherein the processor is further configured to record a product ID, the tag ID, and a scan history of the tag in the electronic certificate.

7. A method for managing product ownership comprising:
scanning, by a device, an electronic tag having a tag ID;
transmitting, by the device, the tag ID to a server;
matching, by the server, the tag ID to a certificate associated with a product;
retrieving, by the server, a product information and an ownership information based on the certificate;
transmitting, by the server, the product information and the ownership information to the device; and
displaying, by the device, the product information and the ownership information on an interface.

8. The method of claim 7 further comprising:
associating the tag ID with the certificate;
associating the certificate with a current owner; and
registering the certificate in a ledger.

9. The method of claim 8, wherein the ledger includes a blockchain.

10. The method of claim 8 further comprising verifying, by the server, a tap token with the tag ID.

11. A method for managing product ownership comprising:
scanning a tag associated with a certificate unique to a product, the tag having a tag ID and the product having a product ID;
associating an ownership information with the certificate; and
in response to a transfer of ownership, updating the ownership information to reflect a new owner of the product.

12. The method of claim 11, further comprising recording a first entry including the tag ID, the product ID, and the ownership information on a ledger.

13. The method of claim 12, wherein the ledger includes a blockchain.

14. The method of claim 12, wherein the updating the ownership information further comprising recording a second entry including the tag ID, the product ID, information pertaining to a new owner in the ledger.

15. The method of claim 11 further comprising:
selecting, by a first party, a second party of whom to transfer an ownership of the product;
receiving, by the second party, a notification indicating that a transfer of ownership of the product is pending;
scanning, by the second party, the tag; and
accepting, by the second party, the ownership of the product from the first party.

16. The method of claim 15, wherein the selecting further comprising providing a first interface on a first device for the first party to select the second party.

17. The method of claim 15, wherein receiving further comprising providing a second interface including the notification on a second device to the second party.

18. The method of claim 15, wherein the accepting further comprising providing a third interface on a second device to accept the ownership of the product.

19. The method of claim 11 further comprising providing a fourth interface to a first party of the product that the product is lost or missing.

20. The method of claim 19 further comprising in response to the tag being scanned after the product has been reported as lost or missing, notifying the first party of the product.
